(19) United States
(12) Patent Application Publication
(10) Pub. No.: US 2015/0111712 A1
(43) Pub. Date: Apr. 23, 2015

(54) MACHINE FOR MAKING A BAG BOTTOM

(71) Applicants: Roberto Emilio GINGARDI, Rivarossa (TO) (IT); Giuseppe PANEPINTO, San Carlo Canavese (TO) (IT)

(72) Inventors: Roberto Emilio Gingardi, Rivarossa (TO) (IT); Giuseppe Panepinto, San Carlo Canavese (TO) (IT)

(21) Appl. No.: 14/397,978

(22) PCT Filed: Apr. 29, 2013
(86) PCT No.: PCT/IB2013/053369

§ 371 Date: Oct. 30, 2014

(30) Foreign Application Priority Data
Apr. 30, 2012 (IT) TO2012A000381

(51) Int. Cl. B31B 1/26; B31B 29/00

(52) U.S. Cl. CPC B31B 1/26; B31B 29/00
USPC 493/255

(57) ABSTRACT

Machine 2 and associated method for making a bag bottom “B” starts from a single tube-shaped sheet “F”. The machine includes: at least one opening element 21 for spreading apart the tube-shaped sheet “F”, which is positioned between a first portion “s1” and a second portion “s2” of the sheet “F”. At least one actuating device 3 moves the first portion “s1”. The machine further includes at least one first striker element 22 for defining a first folding point for making a first side “l1” of the bag bottom “B” after the first portion “s1” has been moved, and at least one second striker element 23, inclined by an angle “a” relative to the first element 22, for defining a second folding point for making a second side “l2” of the bag bottom “B” after the first portion “s1” has been moved.

The present invention relates to a machine for automatically making a bag bottom, in particular a bottom having congruent angles, by starting from a single sheet.

When manufacturing bags, e.g. shopper bags, by starting from a single sheet, it is necessary to make the bag bottom by appropriately bending the tube in order to create a bottom having congruent angles, into which a reinforcement, e.g. made of cardboard, can be placed.

Machines for making paper bags from a spool are known, wherein the bag bottom is made by moving the tube along a circular path, in particular a wheel, exploiting the elasticity of paper. Such machines are therefore complex and bulky, and only allow making the bag bottom by starting from a paper spool; this means that the sheet, and hence the bag, will have no reinforcements, which would however be useful to stiffen the bag itself and also the sheet during the processing steps.

The step of making the bottom of bags manufactured from a single sheet, in particular a reinforced one, is normally carried out manually, because it is difficult to accurately bend the sheet to obtain a bottom with 90° angles.

Moreover, the presence of reinforcements, normally made of cardboard, make the sheet considerably stiffer, and makes it difficult to create correct folds which are not affected by the shape memory typical of fibrous materials such as paper, which could prevent the bottom from lasting through the subsequent processing steps, e.g. until the bottom parts are glued.

The present invention aims at providing a machine capable of automatically making a bag bottom by starting from a single sheet, which is unaffected by the above-mentioned problems.

One aspect of the present invention relates to a machine having the features set out in the appended claim 1.

A further aspect of the present invention relates to an automatic method for making a bag bottom in accordance with claim 10.

Auxiliary features are set out in the appended dependent claims.

The features and advantages of the present invention will become apparent from the following description of a preferred embodiment thereof and from the annexed drawings, wherein:

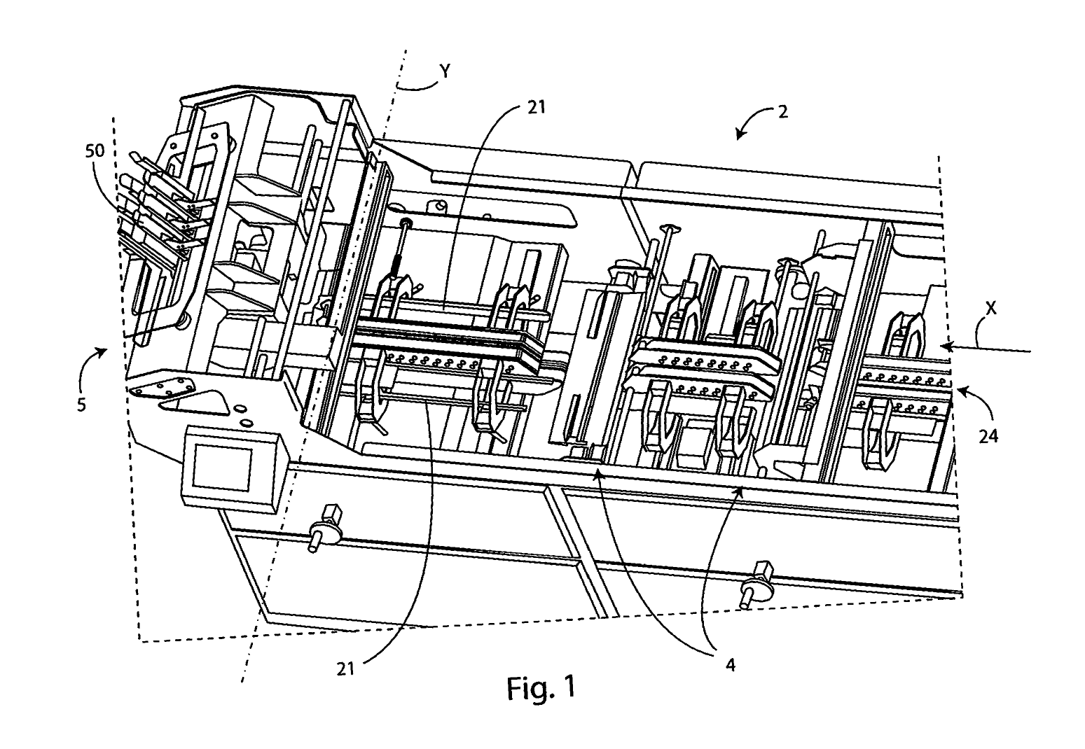

FIG. 1 is a perspective view of the machine as a whole;

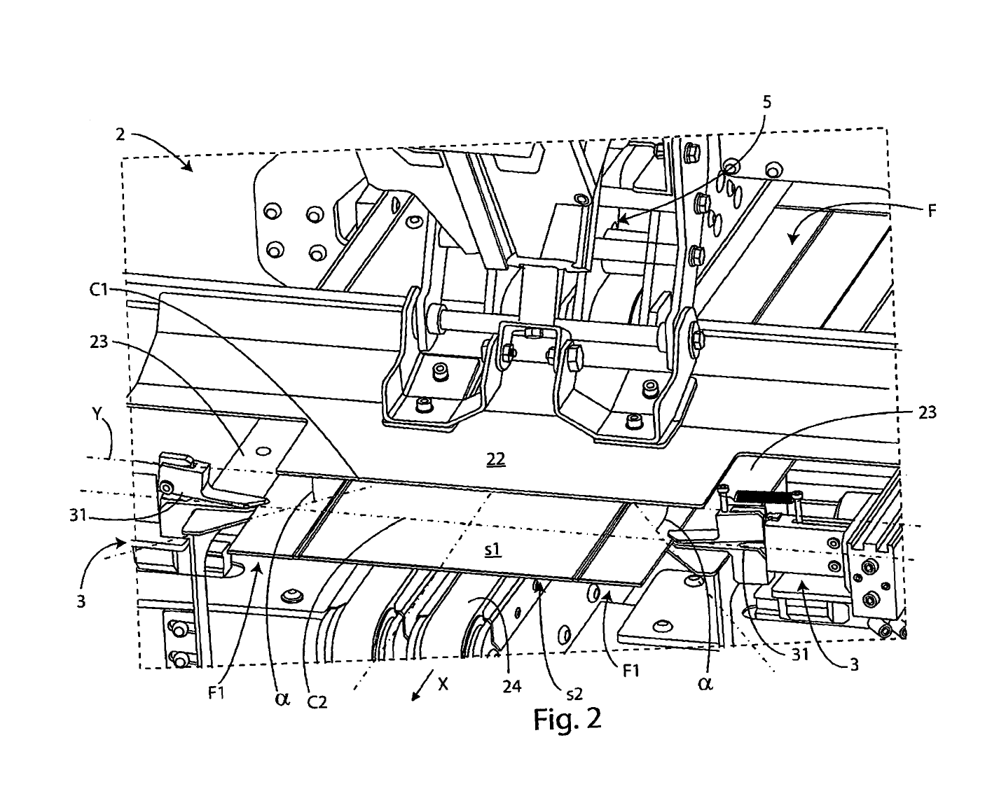

FIG. 2 is a front view of the machine of FIG. 1, wherein the upper portion of the sheet has not yet been moved for making the bag bottom;

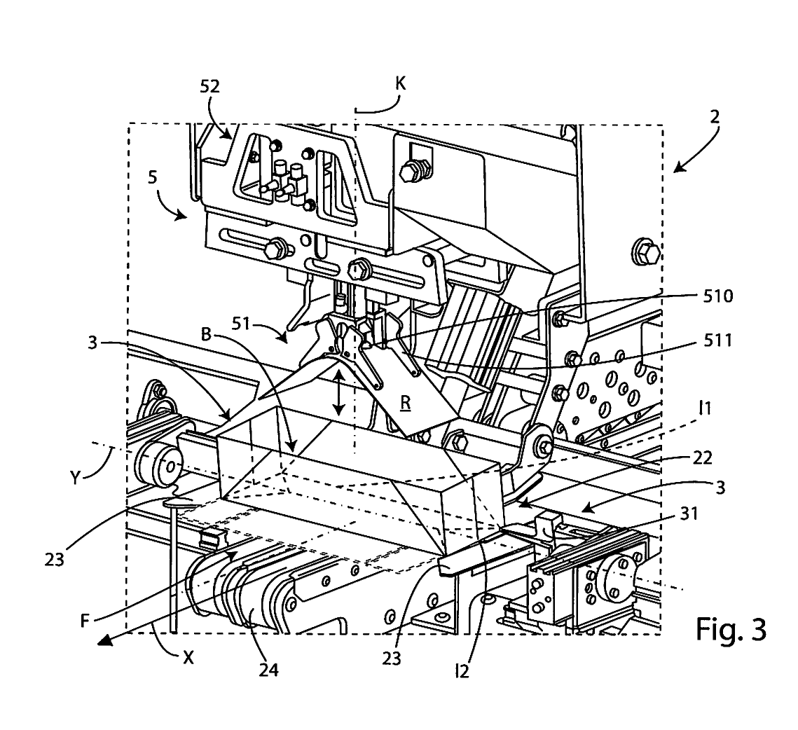

FIG. 3 is a front view of the actuating device after the upper portion has been moved and the bag bottom has been made;

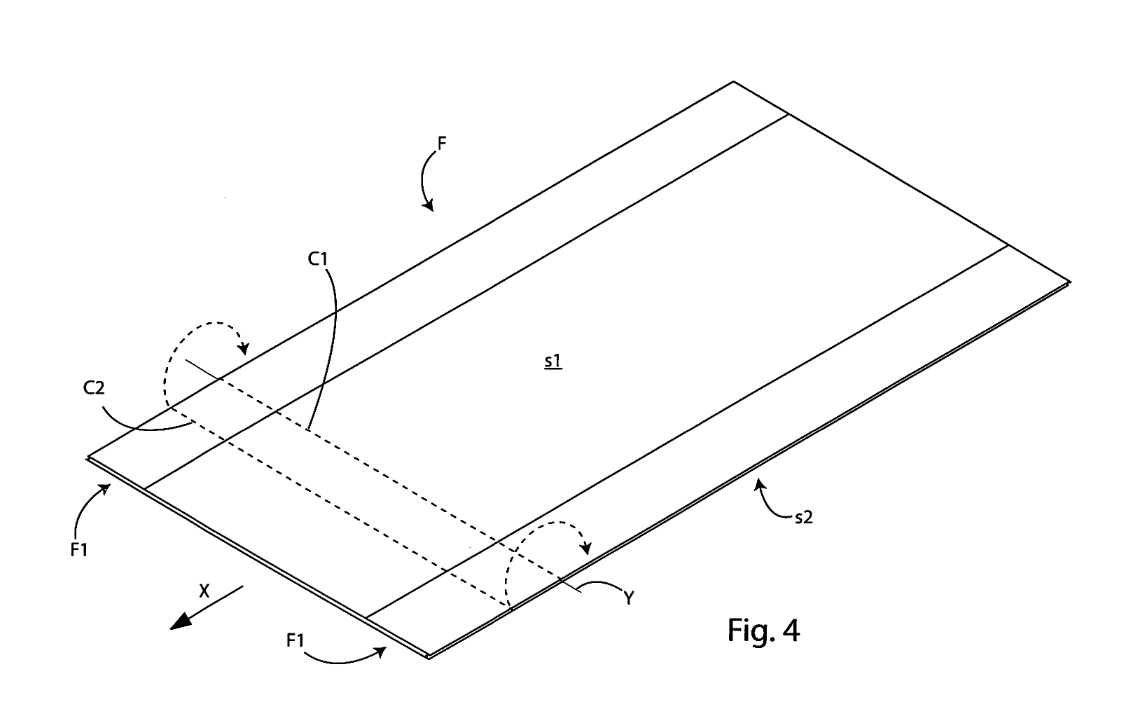

FIG. 4 is a perspective view of the sheet preferably used by the present machine;

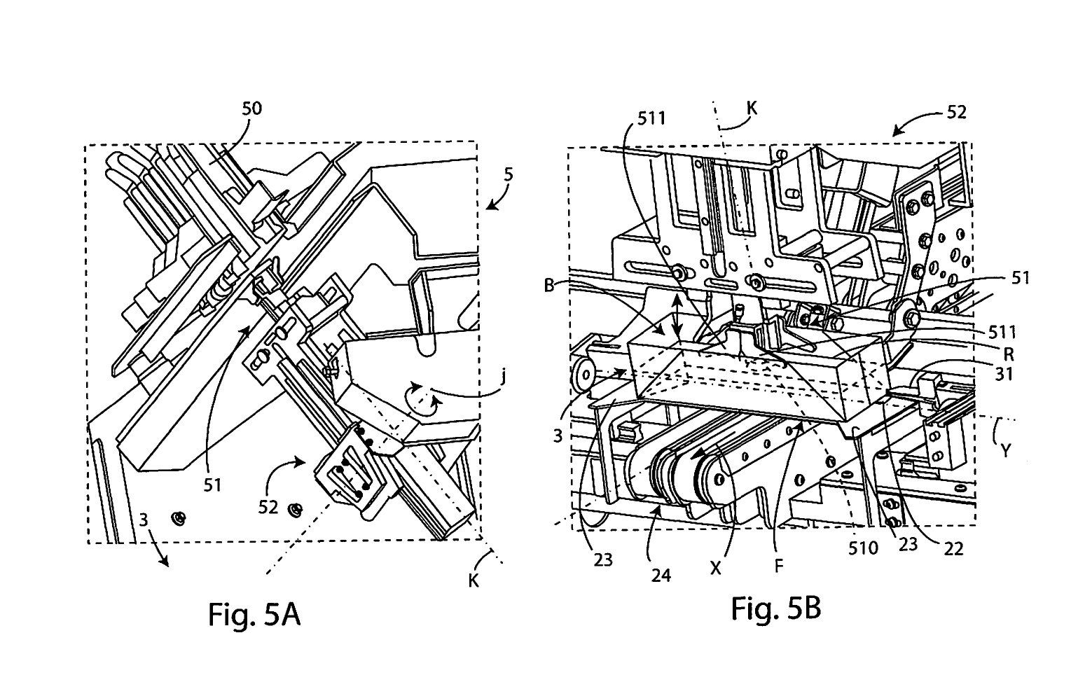

FIGS. 5A and 5B are perspective views of the positioning device in its two operating configurations: FIG. 5A shows the positioning device in the operating configuration; FIG. 5B shows the device in the second operating configuration;

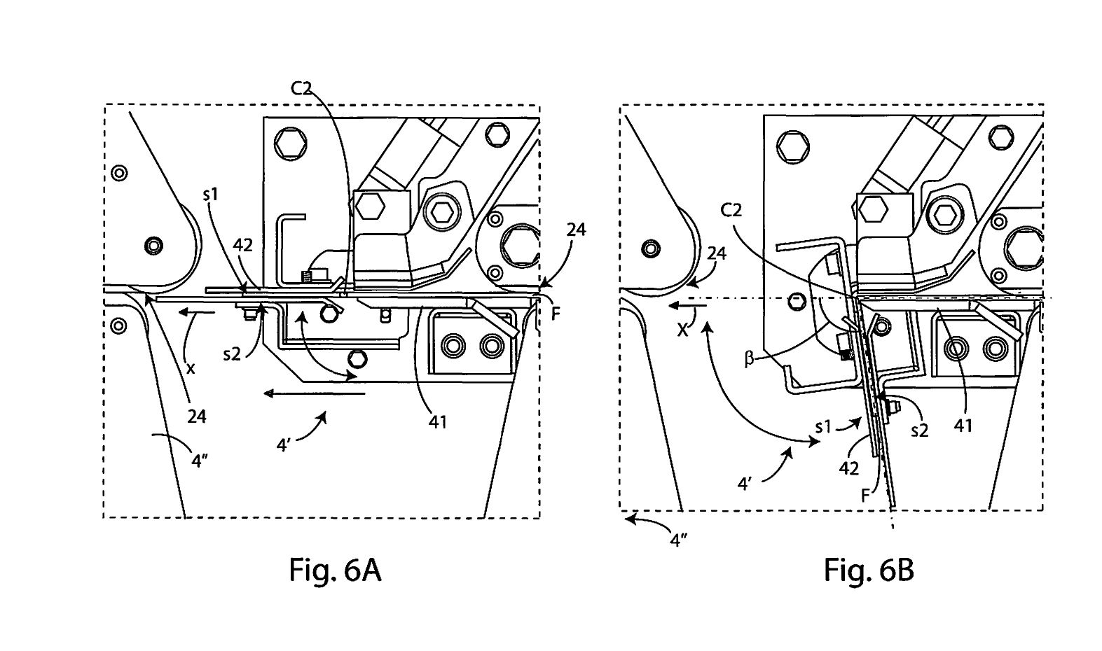

FIGS. 6A and 6B show a detailed side view of the first pre-fracturing device; in particular, FIG. 6A shows the device in a first operating configuration, and FIG. 6B shows it in a second operating configuration;

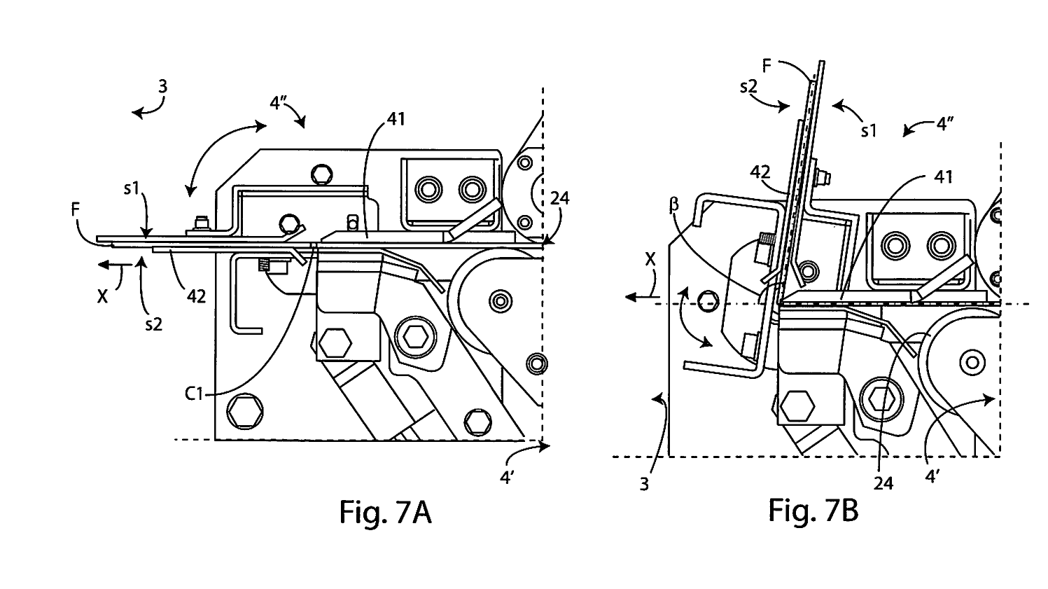

FIGS. 7A and 7B show a detailed side view of the second pre-fracturing device; in particular, FIG. 7A shows the device in a first operating configuration, and FIG. 7B shows it in a second operating configuration.

With reference to the above-mentioned Figures, machine 2 for making a bag bottom “B” by starting from a single tube-shaped sheet “F” comprises at least one opening element 21 for spreading apart sheet “F”, which is positioned between an upper first portion “s1” and a lower second portion “s2”, at least one actuating device 3 for moving said upper first portion “s1”, at least one first striker element 22 for defining a first folding point for making a first side “l1” of the bag bottom “B” after said first portion “s1” has been moved, at least one second striker element 23, inclined by a first angle “α” relative to said first element 22, for defining a second folding point for making a second side “l2” of bag bottom “B” after said first portion “s1” has been moved.

For the purposes of the present invention, a tube-shaped sheet “F” is meant to be a sheet “F” folded over itself, the ends of which are joined, e.g. glued, together. Said sheet is technically referred to as tube. Preferably, said tube is flattened into a flat structure with a first surface “s1” and a second surface “s2”.

As shown in FIG. 4, said tube-shaped sheet “F” preferably comprises two folding portions “F1”, which are specular with respect to a central axis of sheet “F”, and which are obtained during previous processing steps. Said folding portions “F1” extend parallel to said central axis, along the outer edges of sheet “F”. The shape and making of the folding portion of sheet “F” will not be described any further, since it is known to those skilled in the art.

Said sheet “F” is moved along a first axis “X”.

The two above-mentioned folding portions “F1” allow making said first portion or upper portion “s1” and said second portion or lower portion “s2” of sheet “F”.

Said at least one opening element 21 is adapted to open said tube-shaped sheet “F”, extending said folding portions “F1” by interposing itself between said first portion “s1” and said second portion “s2”, externally to sheet “F”, exactly in the positions of folding portions “F1”.

Preferably, there are two opening elements 21 arranged specularly with respect to said central axis of sheet “F”, so that each opening element will act upon the corresponding folding portion “F1”.

For example, each opening element 21 has an elongated shape and comprises a tapered portion adapted to be inserted between said upper portion “s1” and said lower portion “s2”, e.g. at folding portion “F1”, thereby progressively opening said tube. The opening of the tube occurs while moving sheet “F”, by extending folding portion “F1” and placing said two portions (s1, s2) at a known distance.

The opening of sheet “F”, obtained by spreading apart the two portions (s1, s2), is such as to allow actuating device 3 to grip said first portion or upper portion “s1” and impart the movement. By way of example, the spreading apart between the two portions (s1, s2) is smaller than 2 centimetres.

Said first striker element 22 is preferably a sheet-metal part, one side of which defines a first folding point for making a first side “l1” and is arranged along a second axis “Y”, perpendicular to said first axis “X” of motion of sheets “F”.

Said at least one second striker element 23 has an angle “α” of 45° . In the preferred embodiment, said second striker elements 23 are two, positioned specularly with respect to the central axis of the sheet, which is parallel to the above-mentioned first axis “X”; for example, they are interposed between said first portion or upper portion “s1” and said second portion or lower portion “s2”, at folding portions “F1”. When moving upper portion “s1”, said second striker element prevents the lower portion from moving, while at the same time defining a folding point for making the second side “l2” of bag bottom “B”.

Machine 2 preferably comprises two actuating devices 3 arranged specularly with respect to said central axis of sheet “F”, preferably consisting of pneumatic actuators.

Each actuating device 3 comprises at least one gripping element 31, which is adapted to grip said first portion or upper portion “s1” so as to allow moving said first portion.

Preferably, each actuating device 3 carries out the movement, synchronously with the other actuating devices 3, by rotating about said second axis “Y”, preferably by an angle of 180°.

Gripping device 31 is preferably a clamp that clamps the first portion or upper portion “s1”.

Sheet “F” preferably comprises creases where the sheet “F” is preferably folded for making the bag bottom “B”, as shown in FIG. 4.

Preferably, machine 2 of the present invention comprises at least one pre-fracturing device 4 for pre-fracturing the fibres of sheet “F” before it is handled by actuating device 3, by switching from a first operating condition to a second operating condition and then back to said first operating condition, as shown in FIGS. 6A, 6B, 7A and 7B.

In the embodiment shown in FIG. 1, machine 2 comprises two pre-fracturing devices (4′, 4″) arranged in series, which are adapted to pre-fracture the fibres at two predetermined points, e.g. at a first crease “C1” and at a second crease “C2”.

Preferably, the distance between said first crease “C1” and said second crease “C2” equals the distance between said at least one first striker element 22 and said at least one actuating device 3. More in detail, prior to being moved by actuating device 3, sheet “F” is preferably so arranged that the first crease “C1” is at the first striker element 22 and the second crease “C2” is at gripping element 31.

Each pre-fracturing device 4 comprises a striker plate 41, for defining a first folding point for pre-fracturing the fibres, and a folding element 42, for pre-fracturing the fibres.

Said folding element 42 rotates about an axis parallel to said axis “Y” by a second angle “β” of at least 90°, and then returns to the home position by rotating by said second angle “β” in the opposite direction.

Preferably, first pre-fracturing device 4′, which is adapted to break the fibres of, for example, the second crease “C2”, has a folding element 42 operating in the direction opposite to that of second pre-fracturing device 4″, which is adapted to break the fibres of, for example, the first crease “C1”, as shown in FIGS. 6B and 7B.

In order to carry sheet “F” through its various devices, machine 2 comprises at least one moving device 24 adapted to move sheets “F” along said first axis “X”, e.g. coming from previous processing stages, such as, for example, the making of folding portions “F1”. More in detail, said moving device 24 is adapted to transport sheet “F” from said at least one pre-fracturing device 4 to said opening element 21.

Said moving device 24 is preferably at least one conveyor belt or a set of conveyor rollers, adapted to carry sheets “F” along the machine of the present invention by means of time-controlled or space-controlled movements.

Machine 2 further comprises a positioning device 5 for reinforcing elements “R”.

Said positioning device 5 is adapted to switch from a pick-up configuration, wherein it picks up said reinforcement “R”, to an operating configuration, wherein it positions said reinforcement “R” onto bag bottom “B”, as shown in FIGS. 5A and 5B.

Device 5 comprises a gripping device 51 for holding said reinforcement “R”, and a handling device 52 for placing said reinforcement “R” onto bag bottom “B” made by the present machine.

Said reinforcement is preferably made of cardboard, and has substantially the same dimensions as, or preferably smaller dimensions than, bag bottom “B”.

In the embodiment shown in the drawings, said positioning device 5 is adapted to pick up, through said gripping device 51, at least one reinforcement “R” appropriately placed in a suitable magazine 50, and to move it close to bag bottom “B” and position it thereon, as a reinforcement element, by means of said handling device 52.

Preferably, said gripping device 51 is a suction device which is connected to a pneumatic circuit (not shown), and which is adapted to hold the sheet through suction force. Gripping element 51 comprises: a suction element 510, bending means 511 for bending reinforcement “R” and facilitate the positioning thereof onto bag bottom “B”.

Preferably, said bending means 511 comprise yielding means, preferably adapted to allow the angles of reinforcement “R” to be properly positioned at the angles of the bag bottom.

Said bending means 511 are preferably two arms arranged specularly with respect to said suction element 510, and adapted to rotate, under the control of an actuator (not shown), about an axis parallel to the first axis “X”. Bending means 511 are adapted to exert a force on said reinforcement “R”, so as to bend the latter to a desired extent, such that no creases will be created on the reinforcement itself.

Said yielding elements are, for example, a portion of bending means 511, and are pivoted and connected to elastic means. When they are subjected to a force in the direction opposite to that applied by bending means 511, the yielding means will rotate about an axis parallel to the first axis “X”, thereby applying a transverse force onto said reinforcement “R”, such that reinforcement “R” can be properly positioned onto bag bottom “B”.

Preferably, handling device 52 rotates about a third axis “j” parallel to axis “Y”, thereby picking up reinforcements “R” from a suitable magazine above actuating device 3, as shown in FIGS. 1 and 5A.

Handling device 52 is also adapted to extend longitudinally to properly position reinforcement “R” along a fourth axis “k”, which is normal to the plane in which gripping device 51 operates.

Said magazine 50 is adapted to be loaded with reinforcements “R”, preferably made of cardboard.

Preferably, magazine 50 comprises movable strikers (not shown), which can be adjusted as a function of the dimensions of reinforcement “R” in use. In fact, the dimensions of reinforcement “R” will vary proportionally to the format and dimensions of bag bottom “B”.

In alternative embodiments, the handling device carries out rotational and linear movements, e.g. in order to switch between the two operating configurations, which are different from those described above depending on where receptacle 50 has been positioned.

Preferably, all the devices included in machine 2 of the present invention are controlled by a central control unit (not shown), which is adapted to activate and deactivate the single devices during the various steps required for making bag bottom “B”.

The method for making a bag bottom “B” by starting from a single tube-shaped sheet is characterized in that it comprises the following steps, which are carried out automatically:
spreading apart tube-shaped sheet “F” into an upper first portion “s1” and a lower second portion “s2”;
appropriately arranging sheet “F” at a first striker element 22 and at a second striker element 23;
moving said first portion or upper portion “s1” and folding said first portion “s1” over itself.

Preferably, the step of spreading apart the sheet is preceded by at least one step of pre-fracturing the sheet “F”, e.g. carried out by said pre-fracturing device 4.

The preferred embodiment includes two consecutive pre-fracturing steps for fracturing the fibres of sheet “F” at the first crease “C1” and at the second crease “C2”. In particular, sheet “F” is moved and stops at the first pre-fracturing device 4′, which performs the pre-fracture operation by switching from the first operating configuration to the second operating configuration, shown in FIGS. 6A and 6B, and then returns into the first operating configuration. Preferably, sheet is positioned in a manner such that the second crease “C2” is at striker plate 41. Sheet “F” is then moved again and reaches the second pre-fracturing device 4″, which performs the pre-fracture operation by switching from the first operating configuration to the second operating configuration, shown in FIGS. 7A and 7B, and then returns into the first operating condition. Preferably, sheet “F” is so arranged that the first crease “C1” is at striker plate 41.

In equivalent embodiments, it is possible to reverse the order in which the pre-fracturing steps are carried out, e.g. by first executing the step for the first crease “C1”, by means of the first pre-fracturing device 4′, and then executing the step for the second crease “C2”, by means of the second device 4″.

Said pre-fracturing steps are useful for weakening the fibres at the creases and for facilitating the next steps of the process for making bag bottom “B”, without them being affected by the shape memory which is typical of fibrous materials like paper. In fact, said shape memory might prevent bag bottom “B” from lasting through the subsequent processing steps, e.g. until the parts of bag bottom “B” are glued.

The step of spreading apart sheet “F” is carried out by means of said opening element 21, which spreads apart folding portions “F1” of sheet “F”.

The step of spreading apart sheet “F” is carried out simultaneously with the step of moving sheet “F” between the various devices adapted to implement the method according to the present invention.

Said step of moving sheet “F” is followed by the step of arranging sheet “F”, which was opened during the previous step, in a manner such that the first crease “C1” will be at the first striker element 22. In this position, actuating device 3, in particular gripping element 31, will be at the second crease “C2”.

Once sheet “F” has been properly positioned, the step of moving said first portion or upper portion “s1” is carried out. Said step is carried out by said actuating device 3, which makes a rotation, e.g. by 180°, and folds said first portion “s1” over itself.

The first striker element 22, lying at the axis of rotation of actuating device 3, allows making the correct fold and defining the first side “l1” of bag bottom “B”.

While moving under the action of actuating device 3, sheet “F”, in particular folding portion “F1”, will abut on the second striker element 23 arranged at 45°, thereby making the correct fold for bag bottom “B” and defining the second side “l2”.

The method of the present invention further comprises a step of positioning a reinforcement “R” onto bag bottom “B”, carried out by said positioning device 5. Said step is executed after the step of moving the first portion or upper portion “s1”.

The same positioning device, during the above-mentioned step of moving, carries out a further step of picking up a reinforcement “R” from said receptacle 50.

Once bag bottom “B” has been made, all the devices included in the machine will return into a configuration that will allow them to carry out the steps of the present method upon another sheet “F”.

Preferably, machine 2 according to the present invention is comprised in an apparatus for making bags, e.g. shopper bags, by starting from single sheets, preferably provided with reinforcements, e.g. made of cardboard.

The machine of the present invention and the method associated therewith allow to automatically make a bag bottom “B” and apply a reinforcement thereto.

The machine allows to implement all the steps of the method in line, thus having limited overall dimensions.

Said machine can also make the bag bottom by using sheets comprising reinforcement portions.

The method and the machine according to the present invention allow to manufacture said bag bottom in series, because when one sheet is at the step of moving the first portion “s1”, the step of pre-fracturing can be carried out on another sheet “F”, etc.

### REFERENCE NUMERALS

MACHINE 2
Opening element 21
First striker element 22
Second striker element 23
Moving means 24
Actuating device 3
Gripping element 31
Pre-fracturing device 4
First pre-fracturing device 4′
Second pre-fracturing device 4″
Striker plate 41
Folding element 42
Positioning device 5
Receptacle 50
Gripping device 51
Suction element 510
Bending means 511
Handling device 52
First angle α
Second angle β
Bottom B
First crease C1
Second crease C2
Sheet F
Folding portion F1
First side l1
Second side l2
Reinforcement R
First portion or upper portion s1
Second portion or lower portion s2
First axis X
Second axis Y
Third axis j
Fourth axis k

1. Machine for making a bag bottom by starting from a single tube-shaped sheet; said machine comprising:
at least one opening element configured for spreading apart the tube-shaped sheet, which is positioned between a first portion and a second portion of the sheet;
at least one actuating device configured for moving said first portion;
at least one first striker element defining a first folding point for making a first side of the bag bottom after said first portion has been moved;
at least one second striker element, inclined by an angle relative to said first element and defining a second folding point for making a second side of the bag bottom after said first portion has been moved.

2. The machine according to claim 1, wherein said second striker element has an angle of 45°.

3. The machine according to claim 1, comprising at least one pre-fracturing device for pre-fracturing fibres of the sheet prior to movement caused by the actuating device.

4. The machine according to claim 1, comprising a positioning device for reinforcing elements, which comprises a gripping device for holding a reinforcement, and a moving device for placing said reinforcement onto the bag bottom.

5. The machine according to claim 1, comprising moving means for moving the sheet along a first axis, which are adapted to carry the sheet along said machine.

6. The machine according to claim 1, comprising two opening elements arranged specularly with respect to a central axis of the sheet and acting along outer edges of the sheet.

7. The machine according to claim 5, wherein said at least one actuating device comprises at least one gripping element for gripping said first portion while rotating about a second axis perpendicular to said first axis.

8. The machine according to claim 4, wherein the gripping device comprises:
a suction element,
bending means for bending the reinforcement.

9. The machine according to claim 3, wherein each pre-fracturing device comprises a striker plate, for defining a first folding point for pre-fracturing the fibres, and a folding element, for pre-fracturing the fibres.

10. Method for making a bag bottom from a single tube-shaped sheet, comprising the following steps, which are carried out automatically:
spreading apart the tube-shaped sheet into a first portion and a second portion;
arranging the first portion at a first striker element and at a second striker element;
moving said first portion and folding said first portion.

11. The method according to claim 10, comprising at least one step of pre-fracturing the sheet carried out prior to the step of spreading apart the sheet.

12. The method according to claim 10, comprising a step of positioning a reinforcement onto the bag bottom.

13. The method according to claim 10, wherein the step of spreading apart the sheet is carried out simultaneously with a step of moving the sheet between devices adapted to implement the method.

14. Apparatus for making bags from a single sheet, comprising a machine according to claim 1.
